(19) United States
(12) Patent Application Publication
(10) Pub. No.: US 2026/0322054 A1
(43) Pub. Date: Oct. 15, 2026

(54) ELECTRIFIED VEHICLE

(71) Applicant: TOYOTA JIDOSHA KABUSHIKI KAISHA, Toyota-shi (JP)

(72) Inventor: Tetsuhiro TAKENAKA, Miyoshi-shi (JP)

(73) Assignee: TOYOTA JIDOSHA KABUSHIKI KAISHA, Toyota-shi (JP)

(21) Appl. No.: 19/325,006

(22) Filed: Sep. 10, 2025

(30) Foreign Application Priority Data
Jan. 29, 2025 (JP) 2025-013052

(51) Int. Cl. H01R 43/00; B60L 50/60

(52) U.S. Cl. CPC H01R 43/002; B60L 50/66; H01R 2201/26

(57) ABSTRACT

An electrified vehicle includes, on a floor panel that is a partition configured to separate an inside and an outside of a vehicle cabin, a service hole for visual inspection of a connector of a high-voltage cable installed at the outside of the vehicle cabin. The service hole includes a region such that a line segment is drawable between the service hole and the connector without passing through another member.

### CROSS-REFERENCE TO RELATED APPLICATION

This application claims priority to Japanese Patent Application No. 2025-013052 filed on Jan. 29, 2025. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

An electrified vehicle includes an electric drive unit that generates a drive force for vehicle traveling by receiving electric power supply. The electrified vehicle includes a battery electrified vehicle and a hybrid electrified vehicle. The battery electrified vehicle includes solely the electric drive unit as a drive source for vehicle traveling. The hybrid electrified vehicle includes an electric drive unit and an internal combustion engine as a drive source for vehicle traveling. The hybrid electrified vehicle includes a plug-in hybrid electrified vehicle having an external charging function.

The electric drive unit of the electrified vehicle is provided with a connector for connecting a high-voltage cable. In the maintenance of the electrified vehicle, presence or absence of deterioration or damage of the connector may be inspected. Japanese Unexamined Patent Application Publication No. 2023-97054 (JP 2023-97054 A) discloses an electrified vehicle. In the electrified vehicle, a connector between a high-voltage cable and an electric drive unit is provided in a portion on a lower side of a vehicle body of the electric drive unit. The electrified vehicle includes a cover that covers the connector and the vicinity thereof and that is detachable.

### SUMMARY

In the electrified vehicle, by removing the cover, access to the connector of the electric drive unit from a lower side of the vehicle is possible. Therefore, visual inspection of the connector can be performed without removing a heavy component such as the electric drive unit from the electrified vehicle. However, in order to perform the visual inspection of the connector, the entirety of the electrified vehicle needs to be jacked up to a height at which an inspection worker can enter under the vehicle body.

An electrified vehicle includes
a partition configured to separate an outside and an inside of the electrified vehicle,
a connector for a high-voltage cable installed at the outside, and
a service hole provided on the partition.
   The service hole of the electrified vehicle includes a region such that a line segment is drawable between the service hole and the connector without passing through another member.

The electrified vehicle has an effect of facilitating the visual inspection of the connector for the high-voltage cable.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an arrangement of high-voltage system components as viewed from a lateral side of a vehicle in an embodiment of the electrified vehicle;

FIG. 2 is a diagram schematically showing an arrangement of high-voltage system components as viewed from an upper side of the vehicle;

FIG. 3 is a diagram showing an arrangement of service holes provided in a floor panel;

FIG. 4 is a cross-sectional view of the vicinity of the service hole; and

FIG. 5 is a cross-sectional view showing a state of the vicinity of the service hole during a visual inspection.

### DETAILED DESCRIPTION OF EMBODIMENTS

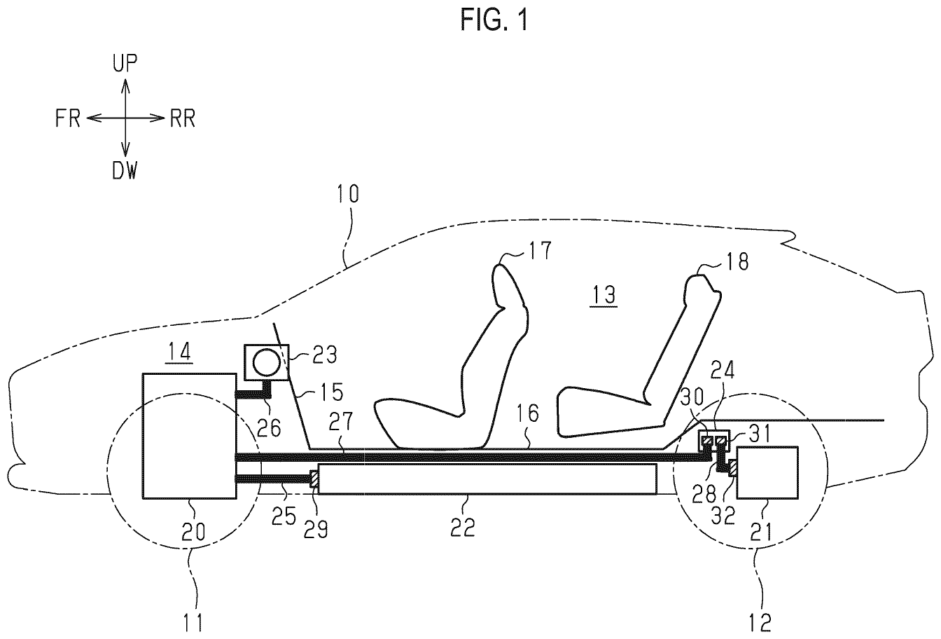

Hereinafter, an embodiment of the electrified vehicle will be described in detail with reference to FIGS. 1 to 5. Among the arrows shown in each of the drawings, “FR” indicates a front of the vehicle, “RR” indicates a rear of the vehicle, “LF” indicates a left side of the vehicle, “RF” indicates a right side of the vehicle, “UP” indicates an upper side of the vehicle, and “DW” indicates a lower side of the vehicle. The electrified vehicle 10 of the present embodiment is configured as a hatchback type battery EV.

### Layout of Electrified Vehicle 10

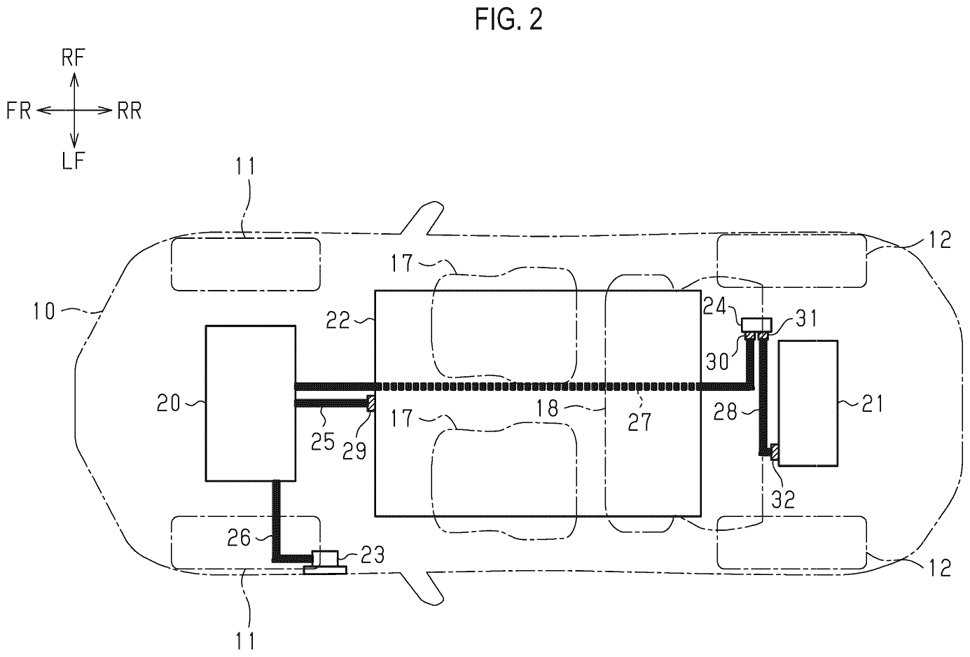

First, the configuration of the electrified vehicle 10 will be described with reference to FIGS. 1 and 2. FIG. 1 shows a disposition of an internal structure of the electrified vehicle 10 as viewed from the left side LF of the vehicle, and FIG. 2 shows a disposition of an internal structure of the electrified vehicle 10 as viewed from the lower side DW of the vehicle, respectively.

The electrified vehicle 10 includes four wheels, namely right and left front wheels 11 and right and left rear wheels 12. Inside the electrified vehicle 10, two compartments, namely a vehicle cabin 13 and a front compartment 14, are provided. The front compartment 14 is provided in a portion disposed forward FR of the vehicle cabin 13 in the front-rear direction of the electrified vehicle 10. The vehicle cabin 13 and the front compartment 14 are partitioned by a dash panel 15. A floor surface of the vehicle cabin 13 is constituted by a floor panel 16. Inside the vehicle cabin 13, two rows of seats, that is, a front seat 17 and a rear seat 18, are installed. In the electrified vehicle 10 of the present embodiment, the dash panel 15 and the floor panel 16 constitute a partition that separates the inside and the outside of the vehicle cabin 13, that is, the inside and the outside of the electrified vehicle 10.

### Configuration of High-Voltage System of Electrified Vehicle 10

The electrified vehicle 10 includes two electrical systems, that is, a high-voltage system and a low-voltage system. The high-voltage system is an electrical system having a high voltage used for traveling or the like of the electrified vehicle 10, and the low-voltage system is an electrical system having a low voltage used for lighting or the like. The configuration of the high-voltage system of the electrified vehicle 10 will be described below.

Inside the front compartment 14, an electric drive unit 20 on the front side for driving the front wheels 11 is installed. An electric drive unit 21 on the rear side for driving rear wheels 12 is disposed in a portion of the lower side DW of the vehicle, below a floor panel 16 disposed in the rear RR of the electrified vehicle 10. Further, a battery 22 is disposed in a portion of the lower side DW of the vehicle, below the floor panel 16 disposed between the front wheels 11 and the rear wheels 12 of the electrified vehicle 10. That is, the battery 22 is installed under the floor of the vehicle cabin 13. Further, the electrified vehicle 10 is provided with a power supply port 23 for externally charging the battery 22. In the case of the electrified vehicle 10 of the present embodiment, the power supply port 23 is installed in a portion of the left side surface disposed forward FR of the vehicle cabin 13 in the front-rear direction of the vehicle. A motor that generates a drive force by receiving electric power supply is installed in the electric drive units 20, 21 on the front side and the rear side.

In the case of the electrified vehicle 10 of the present embodiment, a power control circuit of a motor on the front side, a power control circuit of a motor on the rear side, and a charging circuit of the battery 22 are installed in the electric drive unit 20 on the front side. The battery 22 is connected to the electric drive unit 20 on the front side via the high-voltage cable 25, and the power supply port 23 is connected to the electric drive unit 20 on the front side via the high-voltage cable 26, respectively. In addition, the electric drive unit 20 on the front side is connected to the electric drive unit 21 on the rear side via two high-voltage cables 27, 28 that are connected to each other in a terminal base 24. The terminal base 24 is installed in a portion of a lower side DW of the vehicle, below the floor panel 16 disposed in the rear RR of the electrified vehicle 10 in the front-rear direction of the vehicle.

In the electrified vehicle 10, the battery 22 is a power supply of the high-voltage system, and the high-voltage system is constituted by each of the members connected through the high-voltage cables 25, 26, 27, 28. In the electrified vehicle 10 of the present embodiment, the battery 22, the electric drive unit 20 on the front side, the electric drive unit 21 on the rear side, the power supply port 23, and the terminal base 24 correspond to the high-voltage system members.

The connector 29 between the battery 22 and the high-voltage cable 25 is installed on a side surface disposed forward FR of the battery 22 in the front-rear direction of the vehicle. The connectors 30, 31 between the terminal base 24 and the high-voltage cables 27, 28 are installed on a side surface of the terminal base 24 on the left side LF of the vehicle. The connector 32 between the electric drive unit 21 on the rear side and the high-voltage cable 28 is installed on a side surface disposed forward FR of the electric drive unit 21 in the front-rear direction of the vehicle. The connectors 29, 30, 31, 32 are installed on a portion of a high-voltage device that is installed other than the upper surface thereof. In addition, the connectors 29, 30, 31, 32 are installed outside the electrified vehicle 10, that is, outside the vehicle cabin 13. Further, the connectors 29, 30, 31, 32 are installed under the floor of the vehicle cabin 13 that is close to a road surface. A plurality of connectors for connecting the high-voltage device and the high-voltage cable is installed in the electrified vehicle 10 in addition to the connectors 29, 30, 31, 32, but the connectors are installed on a portion that is separated from the upper surface of the high-voltage device or the road surface. Therefore, the connectors 29, 30, 31, 32 are more likely to be exposed to splashes of water kicked up from the road surface, and are connectors in which deterioration such as soiling or corrosion due to the water is likely to occur, as compared with other connectors.

### Structure for Visual Inspection of Connectors 29, 30, 31, 32

It is desirable to perform the visual inspection of the connectors 29, 30, 31, 32 during the regular inspection or the like of the electrified vehicle 10 to confirm the presence or absence of the deterioration due to the water. The electrified vehicle 10 of the present embodiment has a structure for making it easier to visually inspect the connectors 29, 30, 31, 32.

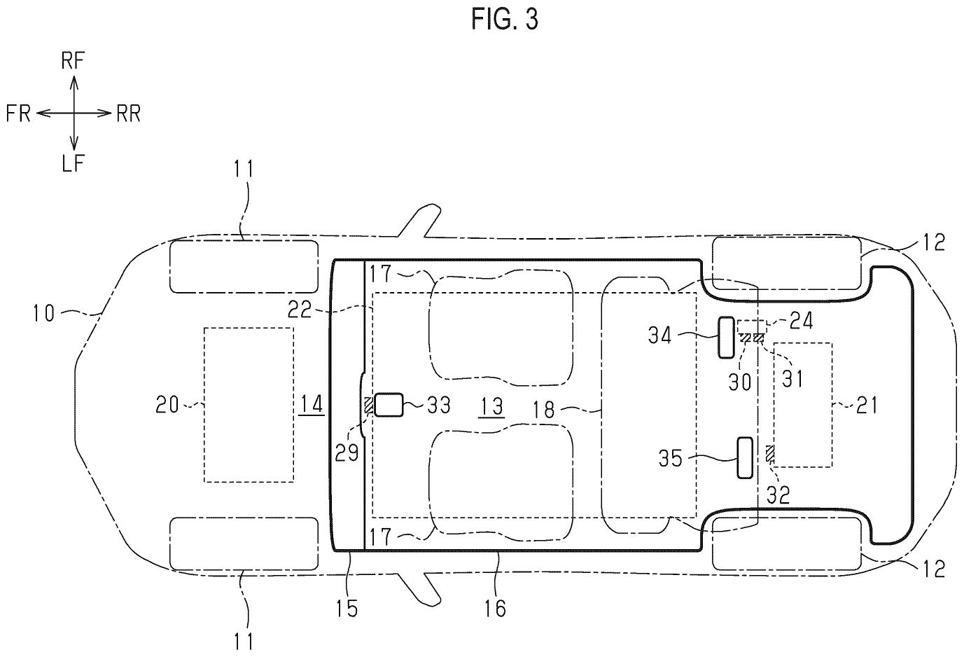

FIG. 3 shows a planar structure of the dash panel 15 and the floor panel 16 as viewed from the upper side UP of the vehicle. Three service holes 33, 34, 35 are provided in the floor panel 16. The service holes 33, 34, 35 are openings that allow communication between the inside and the outside of the vehicle cabin 13, and that are provided in the floor panel 16. Among the three service holes 33, 34, 35, the service hole 33 is installed in a portion in the vicinity of the connector 29 installed in the battery 22. In addition, the service hole 34 is installed in a portion in the vicinity of the two connectors 30, 31 installed in the terminal base 24. Further, the service hole 35 is provided in a portion in the vicinity of the connector 32 installed in the electric drive unit 21 on the rear side. More specifically, the service hole 33 is provided at a central portion of an end portion in a vehicle width direction disposed forward FR of the floor panel 16 in the front-rear direction of the vehicle. In addition, the service holes 34, 35 are provided respectively in portions rearward RR of the rear seat 18 in the front-rear direction of the vehicle on the floor panel 16. Among the portions of the floor panel 16, the portion in which the service hole 33 is provided is a portion of the floor surface of the vehicle cabin 13 that is accessible from the inside of the vehicle cabin 13 without moving or removing another member. In addition, the portions in which the remaining two service holes 34, 35 are provided are portions that are accessible from the inside of the vehicle cabin 13 by tilting the backrests of the rear seat 18 forward.

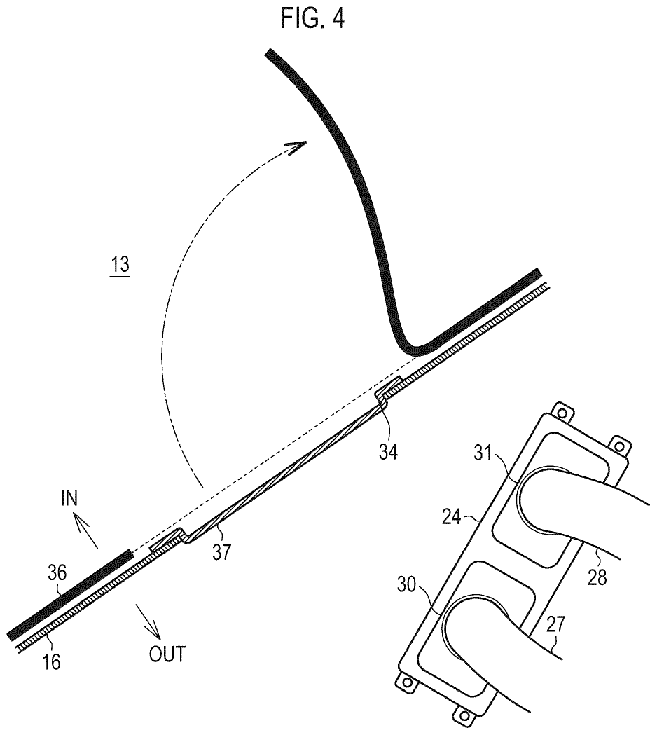

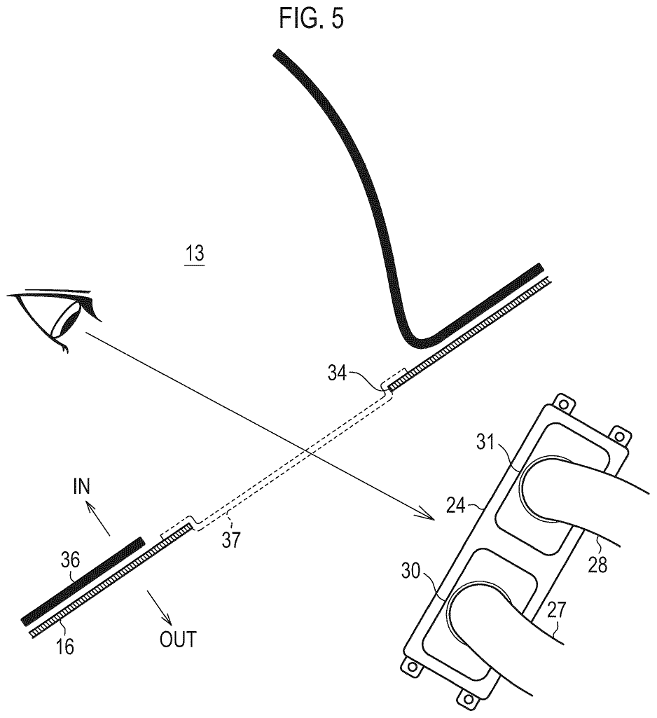

FIG. 4 shows the service hole 34 and a cross-sectional structure around the service hole 34 for inspecting two connectors 30, 31 provided in the terminal base 24. An arrow “IN” in FIG. 4 and FIG. 5 to be described later indicates a direction from the floor panel 16 toward the inside of the vehicle cabin 13, and an arrow “OUT” indicates a direction from the floor panel 16 toward the outside of the vehicle cabin 13, respectively. As shown in FIG. 4, an indoor side of the floor panel 16 is covered with a floor carpet 36. A cut is provided in the floor carpet 36 such that a portion of the floor carpet 36 around the service hole 34 can be rolled up. A cap 37 that covers the service hole 34 is attached to the floor panel 16. The cap 37 is attached to the floor panel 16 in a state where the cap 37 is detachable from the vehicle cabin 13 side. In the present embodiment, the cap 37 is fixed to the floor panel 16 by being fitted into the service hole 34. The service hole 34 is provided in a portion in which other members that obstruct a line of sight to the connectors 30, 31 to be inspected are not present. The service hole 34 includes a region such that a line segment is drawable between the service hole 34 and the connectors 30, 31 without passing through another member.

In contrast, the service hole 33 includes a region such that a line segment is drawable between the service hole 33 and the connector 29 provided in the battery 22 without passing through another member. In addition, the service hole 35 includes a region such that a line segment is drawable between the service hole 35 and the connector 32 provided in the electric drive unit 21 on the rear side without passing through another member. The configuration of the service holes 33, 35 other than the above is the same as the configuration of the service hole 34 shown in FIG. 4.

### Operation of Embodiment

The electrified vehicle 10 configured as described above includes the service holes 33, 34, 35 provided in the floor panel 16 that is a partition separating the inside and the outside. The service holes 33, 34, 35 are provided to correspond respectively to the connectors 29, 30, 31, 32 of the high-voltage cables 25, 27, 28 installed outside. Each of the service holes 33, 34, 35 includes a region such that a line segment is drawable between the service holes 33, 34, 35 and the connectors 29, 30, 31, 32 that are corresponding without passing through another member. In the electrified vehicle 10 configured as described above, each of the connectors 29, 30, 31, 32 can be visually recognized by looking into each of the service holes 33, 34, 35 from the vehicle cabin 13.

FIG. 5 shows a situation during the visual inspection of the two connectors 30, 31 provided in the terminal base 24. As shown in FIG. 5, when the portion of the floor carpet 36 around the service hole 34 is rolled up and the cap 37 is removed, the service hole 34 is exposed in the vehicle cabin 13. Accordingly, the connectors 30, 31 can be visually recognized by looking into the service hole 34 that is exposed, from the inside of the vehicle cabin 13. In this way, in the electrified vehicle 10 of the present embodiment, the visual inspection of the connectors 30, 31 can be performed from the inside of the vehicle cabin 13. Similarly, a visual inspection of the connectors 29, 32 can be performed using the service holes 33, 34, respectively.

### Effect of Embodiment

The electrified vehicle 10 of the present embodiment has the following effects.
(1) The electrified vehicle 10 of the present embodiment includes the connectors 29, 30, 31, 32 of the high-voltage cables 25, 27, 28 installed outside. In addition, the electrified vehicle 10 includes the service holes 33, 34, 35 provided in the floor panel 16 that is a partition separating the inside and the outside. The service hole 33 is provided to correspond to the connector 29, the service hole 34 is provided to correspond to the connectors 30, 31, and the service hole 35 is provided to correspond to the connector 32, respectively. Each of the service holes 33, 34, 35 includes a region such that a line segment is drawable between the service holes 33, 34, 35 and the connectors 29, 30, 31, 32 that are corresponding without passing through another member. In the electrified vehicle 10 configured as described above, it is possible to visually recognize each of the connectors 29, 30, 31, 32 from the inside of the vehicle cabin 13 through the service holes 33, 34, 35. Each of the service holes 33, 34, 35 is provided in a portion that is accessible without removing an interior component such as the front seat 17, the rear seat 18, a dashboard, a center console, or an interior panel. Therefore, the visual inspection of each of the connectors 29, 30, 31, 32 can be performed without jacking up the vehicle or detaching a component that is labor-intensive. Accordingly, the electrified vehicle 10 of the present embodiment has an effect of making it easier to perform the visual inspection of the connectors 29, 30, 31, 32 of the high-voltage cables 25, 27, 28.
(2) Each of the service holes 33, 34, 35 is provided in the floor panel 16. The configuration described above indicates that each of the service holes 33, 34, 35 is provided for the visual inspection of the connectors 29, 30, 31, 32 installed under the floor of the vehicle cabin 13. The connectors 29, 30, 31, 32 installed on a portion that is under the floor of the vehicle cabin 13 and that is close to the road surface are more susceptible to water exposure than the connectors installed in other portions of the electrified vehicle 10, and thus need to be inspected more frequently. As described above, the electrified vehicle 10 of the present embodiment provides means for easily performing the visual inspection on the connectors 29, 30, 31, 32 that have a high need for inspection.
(3) Each of the service holes 33, 34, 35 is provided for the visual inspection of the connectors 29, 30, 31, 32. The connectors 29, 30, 31, 32 are provided on the battery 22, the electric drive unit 21 on the rear side, and a portion other than the upper surface of the terminal base 24 that are high-voltage system members connected to the high-voltage cables 25, 27, 28 via the connectors 29, 30, 31, 32. The connector provided on a portion other than the upper surface of a high-voltage system member is more likely to be exposed to splashes of water kicked up from the road surface than a connector provided on the upper surface of the high-voltage system member. In this regard, the electrified vehicle 10 of the present embodiment provides the means for easily performing the visual inspection on the connectors 29, 30, 31, 32 that have a high need for inspection.

### Other Embodiments

The present embodiment can be modified and carried out as follows. The present embodiment and the following modifications can be carried out in combination within a technically consistent range.

### Regarding Cap 37

The cap 37 may be attached to the floor panel 16 using a bolt or a push pin.
Instead of the cap 37, a door attached to the floor panel 16 with a hinge or the like may be provided to cover the service hole 34.
The cover component, such as the cap 37 or a door, that covers the service holes 33, 34, 35 may not be provided, and the service holes 33, 34, 35 on the vehicle cabin 13 side may be covered solely with the floor carpet 36.

### Regarding Service Hole

The service hole may be provided for the visual inspection of the connector different from the connectors 29, 30, 31, 32. The connector to be visually inspected using the service hole may be a connector installed outside the electrified vehicle 10 and configured to connect the high-voltage cable and the high-voltage system member. For example, the connector may be provided on a high-voltage system member different from the battery 22, the electric drive unit 21, and the terminal base 24. In addition, the connector may be installed on the upper surface of the high-voltage system member.
The number of service holes may be appropriately changed according to the number of connectors to be visually inspected.
The position of the service hole may be appropriately changed according to the position of the connector to be visually inspected. The service hole may be provided in a partition that separates the inside and the outside of the electrified vehicle 10. For example, the service hole may be provided in the dash panel 15. The service hole is desirably provided in a portion of the vehicle cabin 13 that is accessible without removing an interior component other than the cover component of the service hole itself.

### Layout of Electrified Vehicle 10

The type, the number, and the arrangement of each of the high-voltage system members in the electrified vehicle may be appropriately changed. For example, the electrified vehicle 10 may be configured as a two-wheel drive vehicle including a body of any one of the electric drive units 20, 21 on the front side and the rear side.
The electrified vehicle may have a configuration in which the vehicle cabin is divided into two compartments, that is, a passenger compartment on which the occupant seats and a luggage compartment in which the package is loaded.

What is claimed is:

1. An electrified vehicle comprising:
a partition configured to separate an outside and an inside of the electrified vehicle;
a connector for a high-voltage cable installed at the outside; and
a service hole provided on the partition,
wherein the service hole includes a region such that a line segment is drawable between the service hole and the connector without passing through another member.

2. The electrified vehicle according to claim 1, wherein the service hole is provided in a floor panel.

3. The electrified vehicle according to claim 1, wherein the connector is provided on a portion other than an upper surface of a high-voltage system member that is connected to the high-voltage cable via the connector.

4. The electrified vehicle according to claim 1, wherein the connector is configured to connect a battery installed under a floor of the electrified vehicle to the high-voltage cable.

5. The electrified vehicle according to claim 1, wherein the connector is configured to connect an electric drive unit configured to generate a drive force for traveling by receiving electric power supply to the high-voltage cable.
